(19) United States
(12) Patent Application Publication
(10) Pub. No.: US 2004/0243416 A1
(43) Pub. Date: Dec. 2, 2004

(54) Speech recognition

(76) Inventor: Thomas R. Gardos, Somerville, MA (US)

Correspondence Address: FISH & RICHARDSON, PC, 12390 EL CAMINO REAL, SAN DIEGO, CA, 92130-2081, US

(21) Appl. No.: 10/453,447

(22) Filed: Jun. 2, 2003

(51) Int. Cl. G10L 21/00

(52) U.S. Cl. 704/275

(57) ABSTRACT

An apparatus that includes an image capture device and a support. The image capture device captures images of a user's lips, and the support holds the image capture device in a position substantially constant relative to the user's lips as the user's head moves.

### TECHNICAL FIELD

This description relates to speech recognition.

### BACKGROUND

In spoken communication between two or more people, a face-to-face dialog is more effective than a dialog over a telephone, in part because each participant unconsciously perceives and incorporates visual cues into the dialog. For example, people may use visual information of lip positions to disambiguate utterances. An example is the “McGurk effect,” described in “Hearing lips and seeing voices” by H. McGurk and J. MacDonald, Nature, pages 746-748, September 1976.

Another example is the use of visual cues to facilitate “grounding,” which refers to a collaborative process in human-to-human communication. A dialog participant's intent is to convey an idea to the other participant. The speaker sub-consciously looks for cues from the listener that a discourse topic has been understood. When the speaker receives such cues, that portion of the discourse is said to be “grounded.” The speaker assumes the listener has acquired the topic, and the speaker can then build on that topic or move on to the next topic. The cues can be vocal (e.g., “uh huh”), verbal (e.g., “yes”, “right”, “sure”), or non-verbal (e.g., head nods).

Similarly, for human-to-computer spoken interfaces, visual information about lips can improve acoustic speech recognition performance by correlating actual lip position with that implied by the phoneme unit recognized by the acoustic speech recognizer. For example, audio-visual speech recognition techniques that use coupled hidden Markov models are described in “Dynamic Bayesian Networks for Audio-Visual Speech Recognition” by A. Nefian, L. Liang, X. Pi, X. Liu and K. Murphy, EURASIP, Journal of Applied Signal Processing, 11:1-15, 2002; and “A Coupled HMM for Audio-Visual Speech Recognition” by A. Nefian, L. Liang, X. Pi, L. Xiaoxiang, C. Mao and K. Murphy, ICASSP '02 (IEEE Int'l Conf on Acoustics, Speech and Signal Proc.), 2:2013-2016.

The visual information about a person's lips can be obtained by using a high-resolution camera suitable for video conferencing to capture images of the person. The images may encompass the entire face of the person. Image processing software is used to track movements of the head and to isolate the mouth and lips from other features of the person's face. The isolated mouth and lips images are processed to derive visual cues that can be used to improve accuracy of speech recognition.

### DESCRIPTION OF DRAWINGS

FIG. 1 shows a speaker wearing a headset and a computer used for speech recognition.

FIG. 2 shows a block diagram of the headset and the computer.

FIG. 3 shows a portion of the headset facing a speech articulation portion of the user's face.

FIG. 4 shows a communication system in which the headset is used.

FIG. 5 shows a head motion type-to-command mapping table.

FIG. 6 shows an optical assembly.

### DETAILED DESCRIPTION

A telephony-style hands-free headset is used to improve the effectiveness of human-to-human and human-to-computer spoken communication. The headset incorporates sensing devices that can sense both movement of the speech articulation portion of a user's face and head movement.

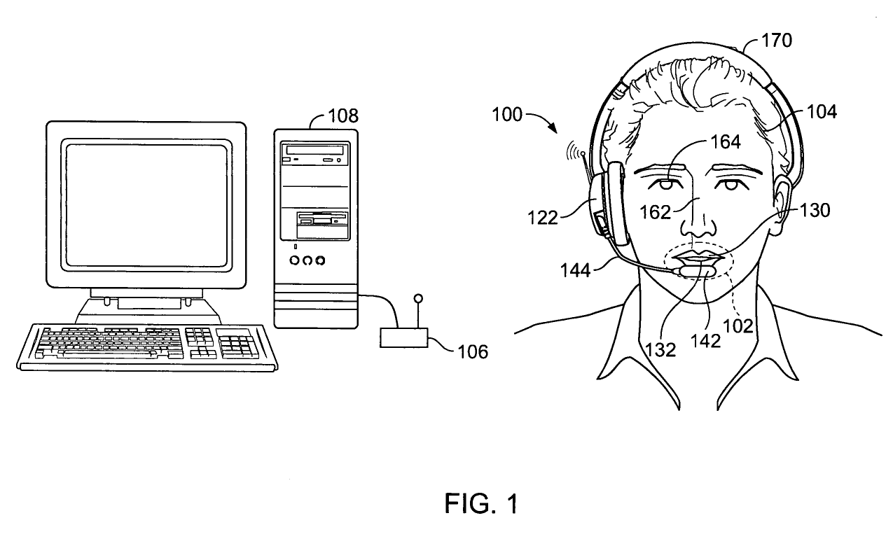

Referring to FIG. 1, a headset 100 configured to detect the positions and shapes of a speech articulation portion 102 of a user's face and motions and orientations of the user's head 104 can facilitate human-to-machine and human-to-human communications. When two people are conversing, or a person is interacting with a spoken language system, the listener may nod his head to emphasize that the words being spoken are understood. When different words are spoken, the speech articulation portion takes different positions and shapes. By determining head motions and orientations, and positions and shapes of the speech articulation portion 102, speech recognition may be made more accurate. Similarly, a listener may nod or shake his head in response to a speaker without saying a word, or may move his mouth without making a sound. These visual cues facilitate communication. The speech articulation portion is the portion of the face that contributes directly to the creation of speech and includes the size, shape, position, and orientation of the lips, the teeth, and the tongue.

Signals from headset 100 are transmitted wirelessly to a transceiver 106 connected to a computer 108. Computer 108 runs a speech recognition program 160 that recognizes the user's speech based on the user's voice, the positions and shapes of the speech articulation portion 102, and motions and orientations of the user's head 104. Computer 108 also runs a speech synthesizer program 161 that synthesizes speech. The synthesized speech is sent to transceiver 106, transmitted wirelessly to transceiver 116, and forwarded to earphone 124.

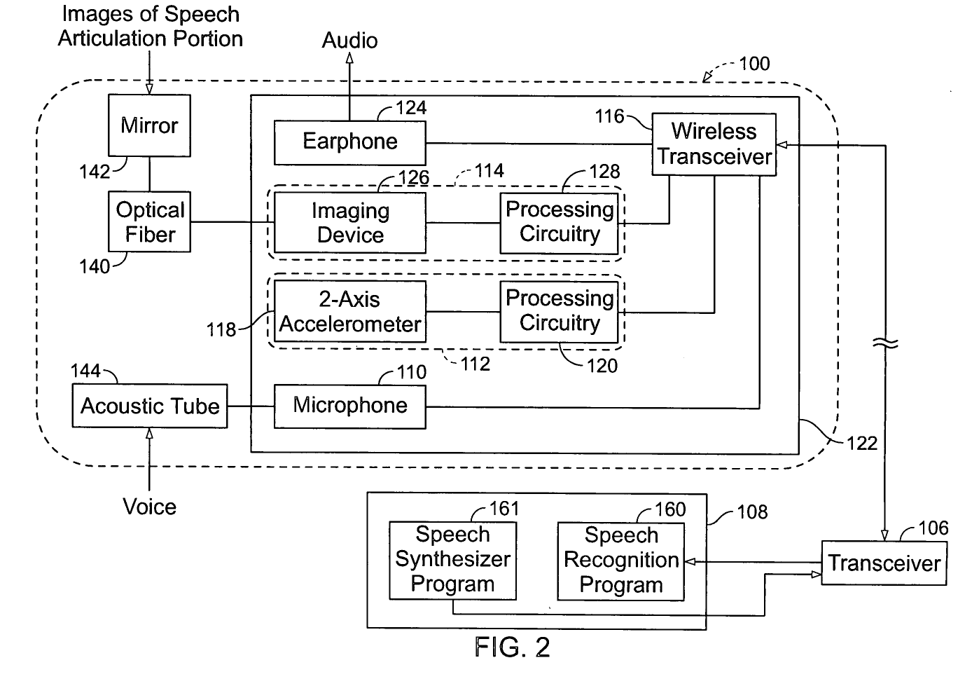

Referring to FIG. 2, in some implementations, headset 100 includes a microphone 110, a head orientation and motion sensor 112, and a lip position sensor 114. Headset 100 also includes a wireless transceiver 116 for transmitting signals from various sensors wirelessly to a transceiver 106, and for receiving audio signals from transceiver 106 and sending them to earphone 124. Headset 100 can be a modified version of a commercially available hands-free telephony headset, such as a Plantronics DuoPro H161N headset or an Ericsson Bluetooth headset model HBH30.

Head orientation and motion sensor 112 includes a two-axis accelerometer 118, such as Analog Devices ADXL202. Sensor 112 may also include circuitry 120 that processes orientations and movements measured by accelerometer 118. Sensor 112 is mounted on headset 100 and integrated into an ear piece 122 that houses the microphone 110, an earphone 124, and sensors 112, 114.

Sensor 112 is oriented so that when a user wears headset 100, accelerometer 118 can measure the velocity and acceleration of the user's head along two perpendicular axes that are parallel to ground. One axis is aligned along a left-right direction (i.e., in the direction defined by a line between the user's ears), and another axis is aligned along a front-rear direction, where the left-right and front-rear directions are relative to the user's head. Accelerometer 118 includes micro-electro-mechanical system (MEMS) sensors that can measure acceleration forces, including static acceleration forces such as gravity. Accelerometer 118 measures head orientation by detecting minute differences in gravitational force detected by the different MEMS sensors. Head gestures, such as a nod or shake, are determined from the signals generated by sensor 112.

Lip position sensor 114 includes an imaging device 126, such as a Fujitsu MB86SO2A 357×293 pixel color CMOS sensor with a 0.14 inch imaging area, or a National Semiconductor LM9630 100×128 pixel monochrome CMOS sensor with a 0.2 inch imaging area. Circuitry 128 that processes images detected by the imaging device may be included in lip position sensor 114. Lip position sensor 114 senses the positions and shapes of the speech articulation portion 102. Portion 102 includes upper and lower lips 130 and mouth 132. Mouth 132 is the region between lips 130, and includes the user's teeth and tongue.

In one example, circuitry 128 may detect features in the images obtained by imaging device 126, such as determining the edges of upper and lower lips by detecting a difference in color between the lips and surrounding skin. Circuitry 128 may output two arcs representing the outer edges of the upper and lower lips. Circuitry 128 may also output four arcs representing the outer and inner edges of the upper and lower lips. The arcs may be further processed to produce lip position parameters, as described in more detail below.

In another example, circuitry 128 compresses the images obtained by imaging device 126 so that a reduced amount of data is transmitted from headset 100. In yet another example, circuitry 128 does not process the images, but merely performs signal amplification.

In one example of using images of speech articulation portion 102 to improve speech recognition, only the positions of lips 130 are detected and used in the speech recognition process. This allows simple image processing, since the boundaries of the lips are easier to determine.

In another example of using images of speech articulation portion 102, in addition to lip positions, the shapes and positions of the mouth 132, including the shapes and positions of the teeth and tongue, are also detected and used to improve the accuracy of speech recognition. Some phonemes, such as the “th” sound in the word “this,” require that a speaker's tongue extend beyond the teeth. Analyzing the positions of a speaker's tongue and teeth may improve recognition of such phonemes.

For simplicity, the following describes an example where lip positions are detected and used to improve accuracy of speech recognition.

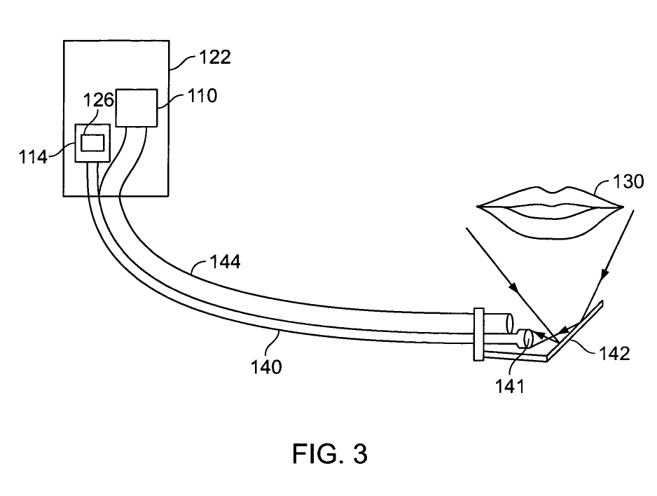

Referring to FIG. 3, in one configuration, lip position sensor 114 is integrated into earpiece 122 and coupled through an optical fiber 140 which lies next to an acoustic tube 144 of the headset 100 to a position in front of the user's lips. Optical fiber 140 has an integrated lens 141 at an end near the lips 130 and a mirror 142 positioned to reflect an image of the lips 130 toward lens 141. In one example, mirror 142 is oriented at 45° relative to the forward direction of the user's face. Images of the user's lips (and mouth) are reflected by mirror 142, transmitted through optical fiber 140, projected onto the imaging device 126, and processed by the accompanying processing circuitry 128.

In an alternative configuration, a miniature imaging device is supported by a mouthpiece positioned in front of the user's mouth. The mouthpiece is connected to earpiece 122 by an extension tube that provides a passage for wires to transmit signals from the imaging device to wireless transceiver 116. Data from head orientation and motion sensor 112 is processed to produce time-stamped head action parameters that represent the head orientations and motions over time. Head orientation refers to the static position of the head relative to a vertical position. Head motion refers to movement of the head relative to an inertial reference, such as the ground on which the user is standing. In one example, the head action parameters represent time, tilt-left, tilt-right, tilt-forward, tilt-back, head-nod, and head-shake. Each of these parameters spans a range of values to indicate the degree of movement. In one example the parameters may indicate absolute deviation from an initial orientation or differential position from the last sample. The parameters are additive, i.e., more than one parameter can have non-zero values simultaneously. An example of such time-stamped head action parameters is MPEG4-facial action parameters proposed by the Moving Picture Experts Group (see http://mpeg.telecomitalialab.com/standards/mpeg-4/mpeg-4.htm, Section 3.5.7).

The head action parameters can be used to increase accuracy of an acoustic speech recognition program 160 running on computer 108. For example, certain values of the head-nod parameter indicate that the spoken word is more likely to have a positive connotation, as in “yes,” “correct,” “okay,” “good,” while certain values of the head-shake parameter indicate that the spoken word is more likely to have a negative connotation, as in “no,” “wrong,” “bad.” As another example, if the speech recognition program 160 recognizes a spoken word that can be interpreted as either “year” or “yeah”, and the head action parameter indicates there was a head-nod, then there is a higher probability that the spoken word is “yeah.” An algorithm for interpreting head motion may automatically calibrate over time to compensate for differences in head movements among different people.

Data from lip position sensor 114 is processed to produce time-stamped lip position parameters. For example, such time-stamped lip position parameters may represent lip closure (i.e., distance between upper and lower lips), rounding (i.e., roundness of outer or inner perimeters of the upper and lower lips), the visibility of the tip of the user's tongue or teeth. The lip position parameters can improve acoustic speech recognition by enabling a correlation of actual lip positions with those implied by a phoneme unit recognized by an acoustic speech recognizer.

Use of spatial information about lip positions is particularly useful for recognizing speech in noisy environments. An advantage of using lip position sensor 114 is that it only captures images of the speech articulation portion 102 and its vicinity, so it is easier to determine the positions of the lips 130. It is not necessary to separate the features of the lips 130 from other features of the face (such as nose 162 and eyes 164), which often requires complicated image processing. The resolution of the imaging device can be reduced (as compared to an imaging device that has to capture the entire face), resulting in reduced cost and power consumption.

Headset 100 includes a headband 170 to support the headset 100 on the user's head 104. By integrating the lip position sensor 114 and mirror 142 with headset 100, lip position sensor 114 and mirror 142 move along with the user's head 104. The position and orientation of mirror 142 remains substantially constant relative to the user's lips 130 as the head 104 moves. Thus, it is not necessary to track the movements of the user's head 104 in order to capture images of the lips 130. Regardless of the head orientation, mirror 142 will reflect the images of the lips 130 from substantially the same view point, and lip position sensor 114 will capture the image of the lips 130 with substantially the same field of view. If the user moves his head without speaking, the successive images of the lips 130 will be substantially unchanged. Circuitry 128 processing images of lips 130 does not have to consider the changes in lip shape due to changes in the angle of view from the mirror 142 relative to the lips 130 because the angle of view does not change.

In one example of processing lip images, only lip closure (i.e., distance between upper and lower lips) is measured. In another example, higher order measurements including lip shape, lip roundness, mouth shape, and tongue and teeth positions relative to the lips 130 are measured. These measurements are “time-stamped” to show the positions of the lips at different times so that they can be matched with audio signals detected by microphone 110.

In alternative examples of processing lip images, where additional information may be needed, lip reading algorithms described in “Dynamic Bayesian Networks for Audio-Visual Speech Recognition” by A. Nefian et al. and “A Coupled HMM for Audio-Visual Speech Recognition” by A. Nefian et al. may be used.

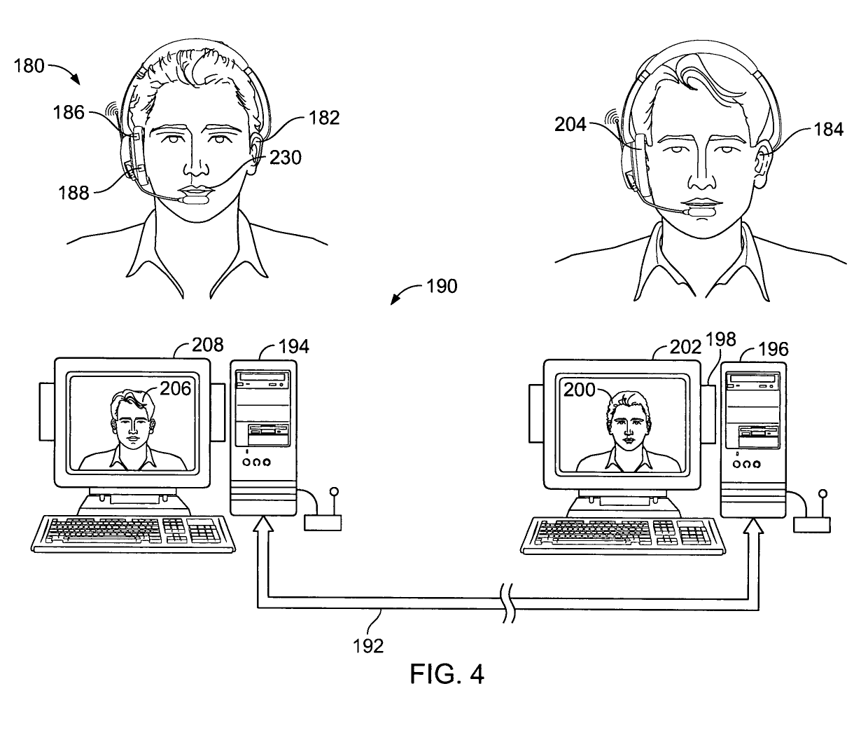

Referring to FIG. 4, a headset 180 is used in a voice-over-internet-protocol (VoIP) system 190 that allows a user 182 to communicate with a user 184 through an IP network 192. Headset 180 is configured similarly to headset 100, and has a head orientation and motion sensor 186 and a lip position sensor 188.

Lip position sensor 188 generates lip position parameters based on lip images of user 182. The head orientation and motion sensor 186 generates head action parameters based on signals from accelerometers contained in sensor 186. The lip position parameters and head action parameters are transmitted wirelessly to a computer 194.

When user 182 speaks to user 184, computer 194 digitizes and encodes the speech signals of user 182 to generate a stream of encoded speech signals. As an example, the speech signals can be encoded according to the G.711 standard (recommended by the International Telecommunication Union, published in November 1988), which reduces the data rate prior to transmission. Computer 194 combines the encoded speech signals and the lip position and head action parameters, and transmits the combined signal to a computer 196 at a remote location through network 192.

At the receiving end, computer 196 decodes the encoded speech signals to generate decoded speech signals, which are sent to speakers 198. Computer 196 also synthesizes an animated talking head 200 on a display 202. The orientation and motion of the talking head 200 are determined by the head action parameters. The lip positions of the talking head 200 are determined by the lip position parameters.

Audio encoding (compression) algorithms reduce data rate by removing information in the speech signal that is less perceptible to humans. If user 182 does not speak clearly, reduction in signal quality caused by encoding will cause the decoded speech signal generated by computer 196 to be difficult to understand. Hearing the decoded speech and seeing the animated talking head 200 with lip actions that accurately mimic those of user 182 at the same time can improve comprehension of the dialog by user 182.

The lip images are captured by lip position sensor 188 as user 182 talks (and prior to encoding of the speech signals), so the lip position parameters do not suffer from the reduction in signal quality due to encoding of speech signals. Although the lip position parameters themselves may be encoded, because the data rate for lip position parameters is much lower than the data rate for the speech signals, the lip position parameters can be encoded by an algorithm that involves little or no loss of information and still has a low data rate compared to the speech signals.

In another mode of operation, computer 194 recognizes the speech of user 182 and generates a stream of text representing the content of the user's speech. During the recognition process, the lip and head action parameters are taken into account to increase the accuracy of recognition. Computer 194 transmits the text and the lip and head action parameters to computer 196. Computer 196 uses a text-to-speech engine to synthesize speech based on the text, and synthesizes the animated talking head 200 based on the lip position and head action parameters. Displaying the animated talking head 200 not only improves comprehension of the dialog by user 184, but also makes the communication from computer 196 to user 184 more natural (i.e., human-like) and interesting.

In a similar manner, user 184 wears a headset 204 that captures and transmits head action and lip position parameters to computer 196, which may use the parameters to facilitate speech recognition. The head action and lip position parameters are transmitted to computer 194, and are used to control an animated talking head 206 on a display 208.

Use of lip position and head action parameters can facilitate “grounding.” During a dialog, the speaker sub-consciously looks for cues from the listener that a discourse topic has been understood. The cues can be vocal, verbal, or non-verbal. In a telephone conversation over a network with noise and delay, if the listener uses vocal or verbal cues for grounding, the speaker may misinterpret the cues and think that the listener is trying to say something. By using the head action parameters, a synthetic talking head can provide non-verbal cues of linguistic grounding in a less disruptive manner.

A variation of system 190 may be used by people who have difficulty articulating sounds to communicate with one another. For example, images of an articulation portion 230 of user 182 may be captured by headset 180, transmitted from computer 194 to computer 196, and shown on display 202. User 184 may interpret what user 182 is trying to communicate by lip reading. Using headset 180 allows user 182 to move freely, or even lie down, while images of his speech articulation portion 230 are being transmitted to user 184.

Another variation of system 190 may be used in playing network computer games. Users 180 and 184 may be engaged in a computer game where user 182 is represented by an animated figure on display 202, and user 184 is represented by another animated figure on display 208. Headset 180 sends head action and lip position parameters to computer 194, which forwards the parameters to computer 196. Computer 196 uses the head action and lip position parameters to generate a lifelike animated figure that accurately depicts the head motion and orientation and lip positions of user 182. A lifelike animated figure that accurately represents user 184 may be generated in a similar manner.

The data rate for the head action and lip position parameters is low (compared to the data rate for images of the entire face captured by a camera placed at a fixed position relative to display 208), therefore the animated figures can have a quicker response time (i.e., the animated figure in display 202 moves as soon as user 180 moves his head or lips).

The head action parameters can be used to control speech recognition software. An example is a non-verbal confirmation of accuracy of the recognition. As the user speaks, the recognition software attempts to recognize the user's speech. After a phrase or sentence is recognized, the user can give a nod to confirm that the speech has been correctly recognized. A head shake can indicate that the phrase is incorrect, and an alternative interpretation of the phrase may be displayed. Such non-verbal confirmation is less disruptive than verbal recognition, such as saying “yes” to confirm and “no” to indicate error.

The head action parameters can be used in selecting an item within a list of items. When the user is presented with a list of items, the first item may be highlighted, and the user may confirm selection of the item with a head nod, or use a head shake to instruct the computer to move on to the next item. The list of items may be a list of emails. A head nod can be used to instruct the computer to open and read the email, while a head shake instructs the computer to move to the next email. In another example, a head tilt to the right may indicate a request for the next email, and a head tilt to the left may indicate a request for the previous email.

Software for interpreting head motion may include a database that includes a first set of data representing head motion types, and a second set of data representing commands that correspond to the head motion types.

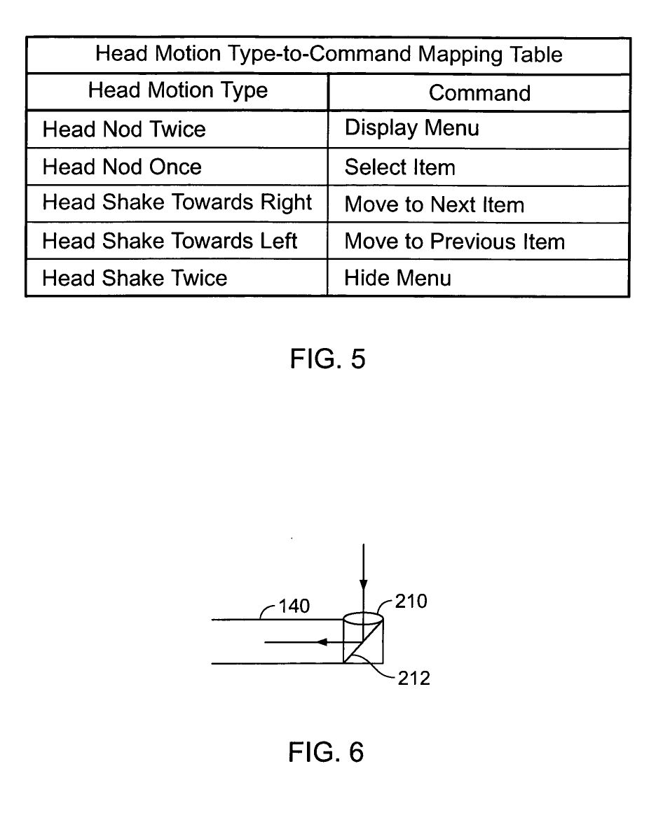

Referring to FIG. 5, a database may contain a table 220 that maps different head motion types to various computer commands. For example, head motion type “head-nod twice” may represent a request to display a menu of action items. The first item on the menu is highlighted. Head motion type “head-nod once” may represent a request to select an item that is currently highlighted. Head motion type “head-shake towards right” may represent a request to move to the next item, and highlight or display the next item. Head motion type “head-shake towards left” may represent a request to move to the previous item, and highlight or display the previous item. Head motion type “head-shake twice” may represent a request to hide the menu.

A change of head orientation or a particular head motion can also be used to indicate a change in the mode of the user's speech. For example, when using a word processor to dictate a document, the user may use one head orientation (such as facing straight forward) to indicate that the user's speech should be recognized as text and entered into the document. In another head orientation (such as slightly tilting down), the user's speech is recognized and used as commands to control actions of the word processor. For example, when the user says “erase sentence” while facing straight forward, the word processor enters the phrase “erase sentence” into the document. When the user says “erase sentence” while tilting the head slightly downward, the word processor erases the sentence just entered.

In the word processor example above, a “DICTATE” label may be displayed on the computer screen while the user is facing straight forward to let the user know that it is currently in the dictate mode, and that speech will be recognized as text to be entered into the document. A “COMMAND” label may be displayed while the user's head is tilted slightly downwards to show that it is currently in the command mode, and the speech will be recognized as commands to the word processor. The word processor may provide an option to allow such function to be disabled, so that the user may move his/her head freely while dictating and not worry that the speech will be interpreted as commands.

Headset 100 can be used in combination with a keyboard and a mouse. The signals from the head orientation and motion sensor 112 and the lip position sensor 114 can be combined with keystrokes, mouse movements, and speech commands to increase efficiency in human-computer communication.

Although some examples have been discussed above, other implementations and applications are also within the scope of the following claims. For example, referring to FIG. 6, optical fiber 140 may have an integrated lens 210 and mirror 212 assembly. The image of the user's speech articulation region is focused by lens 210 and reflected by mirror 212 into optical fiber 140. The signals from the headset 100 may be transmitted to a computer through a signal cable instead of wirelessly.

In FIG. 4, the head orientation and motion sensor 186 may measure the acceleration and orientation of the user's head, and send the measurements to computer 194 without further processing the measurements. Computer 194 may process the measurements and generate the head action parameters. Likewise, the lip position sensor 188 may send images of the user's lips to computer 194, which then processes the images to generate the lip position parameters.

The head orientation and motion sensor 112 and the lip position sensor 114 may be attached to the user's head using various methods. Head band 170 may extend across an upper region of the user's head. The head band may also wrap around the back of the user's head and be supported by the user's ears. Head band 170 may be replaced by a hook-shaped piece that supports earpiece 122 directly on the user's ear. Earpiece 122 may be integrated with a head-mount projector that includes two miniature liquid crystal display (LCD) displays positioned in front of the user's eyes. Head orientation and motion sensor 112 and the lip position sensor 114 may be attached to a helmet worn by the user. Such helmets may be used by motorcyclists or aircraft pilots for controlling voice activated devices.

Headset 100 can be used in combination with an eye expression sensor that is used to obtain images of one or both of the user's eyes and/or eyebrows. For example, raising eyebrows may signify excitement or surprise. Contraction of the eyebrows (frowning) may signify disapproval or displeasure. Such expressions may be used to increase the accuracy of speech recognition.

Movement of the eye and/or eyebrow can be used to generate computer commands, just as various head motions may be used to generate commands as shown in FIG. 5. For example, when speech recognition software is used for dictation, raising the eyebrow once may represent “display menu,” and raising the eyebrow twice in succession may represent “select item.”

A change of eyebrow level can also be used to indicate a change in the mode of the user's speech. For example, when using a word processor to dictate a document, the user's speech is normally recognized as text and entered into the document. When the user speaks while raising the eyebrows, the user's speech is recognized and used as a command (predefined by the user) to control actions of the word processor. Thus, when the user says “erase sentence” while having a normal eyebrow level, the word processor enters the phrase “erase sentence” into the document. When the user says “erase sentence” while raising his eyebrows, the word processor erases the sentence just entered.

Similarly, the user's gaze or eyelid movements may be used to increase accuracy of speech recognition, or be used to generate computer commands.

The left and right eyes (and the left and right eyebrows) usually have similar movements, therefore it is sufficient to capture images of either the left or the right eye and eyebrow. The eye expression sensor may be attached to a pair of eyeglasses, a head-mount projector, or a helmet. The eye expression sensor can have a configuration similar to the lip position sensor 114. An optical fiber with an integrated lens may be used to transmit images of the eye and/or eyebrow to an imaging device (e.g., a camera) and image processing circuitry.

In FIG. 2, in one implementation, wireless transceiver 116 may send analog audio signals (generated from microphone 110) wirelessly to transceiver 106, which sends the analog audio signals to computer 108 through an analog audio input jack. Transceiver 116 may send digital signals (generated from circuitry 112 and 128) to transceiver 106, which sends the digital signals to computer 108 through, for example, a universal serial bus (USB) or an IEEE 1394 Firewire connection. In another implementation, transceiver 106 may digitize the analog audio signals and send the digitized audio signals to computer 108 through the USB or Firewire connection. In an alternative implementation, transceiver 116 may digitize the audio signals and send the digitized audio signals to transceiver 106 wirelessly. Audio and digital signals can be sent from computer 108 to transceiver 116 in a similar manner.

What is claimed is:

1. An apparatus comprising:
an image capture device to capture images of a speech articulation portion of a user; and
a support to hold the image capture device in a position substantially constant relative to the speech articulation portion as a head of the user moves.

2. The apparatus of claim 1 in which the speech articulation portion comprises upper and lower lips of the user.

3. The apparatus of claim 1 in which the speech articulation portion comprises a tongue of the user.

4. The apparatus of claim 1 in which the image capture device is configured to capture images of the speech articulation portion from a distance that remains substantially constant as the user's head moves.

5. The apparatus of claim 4 in which the field of view of the image capture device is confined to upper and lower lips of the user.

6. The apparatus of claim 1 further comprising an audio sensor to sense a voice of the user.

7. The apparatus of claim 6 in which the audio sensor is mounted on the support.

8. The apparatus of claim 1 in which the support comprises a headset.

9. The apparatus of claim 1 further comprising a data processor to recognize speech based on images captured by the image capture device.

10. The apparatus of claim 9 in which the data processor recognizes speech also based on the voice.

11. The apparatus of claim 1 in which the support comprises a mouthpiece to support the image capture device at a position facing lips of the user.

12. The apparatus of claim 1 in which the image capture device comprises a camera.

13. The apparatus of claim 12 in which the image capture device comprises a lens facing lips of the user.

14. The apparatus of claim 12 in which the image capture device comprises a light guide to transmit an image of lips of the user to the camera.

15. The apparatus of claim 12 in which the image capture device comprises a mirror facing lips of the user.

16. The apparatus of claim 1 further comprising a display to show animated lips based on images of the speech articulation portion captured by the image capture device.

17. The apparatus of claim 1 further comprising a motion sensor to detect motions of the user's head.

18. The apparatus of claim 17 further comprising a data processor to generate images of animated lips, the data processor controlling the orientation of the animated lips based in part on signals generated by the motion sensor.

19. The apparatus of claim 18 in which the data processor also controls an orientation of an animated talking head that contains the animated lips based in part on signals generated by the motion sensor.

20. The apparatus of claim 1 further comprising an orientation sensor to detect orientations of the user's head.

21. The apparatus of claim 1 in which the image capture device captures images of at least a portion of an eyebrow or an eye of the user.

22. The apparatus of claim 21 further comprising a data processor to recognize speech based on images captured by the image capture device.

23. An apparatus comprising:
a motion sensor to detect a movement of a user's head;
a headset to support the motion sensor at a position substantially constant relative to the user's head; and
a data processor to generate a signal indicating a type of movement of the user's head based on signals from the motion sensor, the type of movement being selected from a set of pre-defined types of movements.

24. The apparatus of claim 23 in which at least one of the pre-defined types of movements include tilting.

25. The apparatus of claim 24 in which the pre-defined types of movements include tilting left, tilting right, tilting forward, tilting backward, head nod, or head shake.

26. The apparatus of claim 23 in which the signal indicating the type of movement also indicates an amount of movement.

27. The apparatus of claim 26, further comprising a data processor configured to recognize speech based on voice signal and signals from the motion sensor.

28. An apparatus comprising:
an image capture device to capture images of lips of a user;
a motion sensor to detect a movement of a head of the user and generate a head action signal;
a processor to process the images of the lips and the head action signal to generate lip position parameters and head action parameters;
a headset to support the image capture device and the motion sensor at positions substantially constant relative to the user's head as the user's head moves; and
a transmitter to transmit the lip position and head action parameters.

29. The apparatus of claim 28 in which the image capture device comprises a mirror positioned in front of the user's lips.

30. The apparatus of claim 29 in which the image capture device comprises a camera placed in front of the user's lips.

31. A method comprising:
recognizing speech of a user based on images of lips of the user obtained by a camera positioned at a location that remains substantially constant relative to the user's lips as a head of the user moves.

32. The method of claim 31 further comprising measuring a distance between an upper lip and a lower lip of the user.

33. The method of claim 31 further comprising generating time-stamped lip position parameters from images of the user's lips.

34. The method of claim 31 further comprising recognizing speech of the user based on images of at least a portion of the user's eye or eyebrow.

35. The method of claim 31 further comprising controlling a process for recognizing speech based on images of at least a portion of the user's eye or eyebrow.

36. A method comprising at least one of recognizing speech of a user and controlling a machine based on information derived from movements of a head of the user sensed by a motion sensor attached to the user's head.

37. The method of claim 36 further comprising confirming accuracy of speech recognition based on information derived from movements of the user's head sensed by the motion sensor.

38. The method of claim 36 further comprising selecting between different modes of speech recognition based on different head movements sensed by the motion sensor.

39. A method comprising:
obtaining successive images of a speech articulation portion of a face of a user from a position that is substantially constant relative to the user's face as a head of the user moves.

40. The method of claim 39 further comprising detecting a voice of the user.

41. The method of claim 40 further comprising recognizing speech based on the voice and the images of the speech articulation portion.

42. A method comprising:
measuring movement of a user's head to generate a head motion signal;
detecting a voice of the user; and
recognizing speech based on the voice and the head motion signal.

43. The method of claim 42, further comprising processing the head motion signal to generate a head motion type signal.

44. The method of claim 42, further comprising selecting a head motion type from a set of pre-defined head motion types based on the head motion signal, the pre-defined head motion types including at least one of tilting left, tilting right, tilting forward, tilting backward, head nod, and head shake.

45. The method of claim 42 further comprising using recognized speech to control actions of a computer game.

46. The method of claim 42 further comprising generating an animated head within a computer game based on the head motion signal.

47. A method comprising:
generating an animated talking head to represent a speaker; and
adjusting an orientation of the animated talking head based on a head motion signal generated from a motion sensor that senses movements of a head of the speaker.

48. The method of claim 47 further comprising receiving the head motion signal from a network.

49. The method of claim 47 further comprising generating animated lips based images of lips of the speaker captured from a position that is substantially constant relative to the lips as the speaker's head moves.

50. A method comprising:
confirming accuracy of recognition of a speech of a user based on a head action parameter derived from measurements of movements of a head of the user.

51. The method of claim 50 in which the head action parameter comprises a head-nod parameter.

52. The method of claim 50 further comprising measuring movements of the user's head using a motion sensor attached to the user's head.

53. A machine-accessible medium, which when accessed results in a machine performing operations comprising:
recognizing speech of a user based on images of lips of the user obtained by a camera positioned at a location that remains substantially constant relative to the user's lips as a head of the user moves.

54. The machine-accessible medium of claim 53, which when accessed further results in the machine performing operations comprising measuring a distance between an upper lip and a lower lip of the user.

55. The machine-accessible medium of claim 53, which when accessed further results in the machine performing operations comprising generating time-stamped lip position parameters from images of the user's lips.

56. A machine-accessible medium, which when accessed results in a machine performing operations comprising:
measuring movement of a head of a user to generate a head motion signal;
detecting a voice of the user; and
recognizing speech based on the voice and the head motion signal.

57. The machine-accessible medium of claim 56, which when accessed further results in the machine performing operations comprising generating an animated head within a computer game based on the head motion signal.

58. The machine-accessible medium of claim 56, which when accessed further results in the machine performing operations comprising using recognized speech to control actions of a computer game.

59. A machine-accessible medium, which when accessed results in a machine performing operations comprising:
generating an animated talking head to represent a speaker; and
adjusting an orientation of the animated talking head based on a head motion signal generated from a motion sensor that senses movements of a head of the speaker.

60. The machine-accessible medium of claim 59, which when accessed further results in the machine performing operations comprising receiving the head motion signal from a network.

61. The machine-accessible medium of claim 59, which when accessed further results in the machine performing operations comprising generating animated lips based images of lips of the speaker captured from a position that is substantially constant relative to the lips as the speaker's head moves.
